(19) United States
(12) Patent Application Publication
(10) Pub. No.: US 2026/0178373 A1
(43) Pub. Date: Jun. 25, 2026

(54) INTERRUPT REQUEST BALANCING METHOD AND APPARATUS, AND COMPUTING DEVICE

(71) Applicant: HUAWEI TECHNOLOGIES CO., LTD., Shenzhen (CN)

(72) Inventors: Shen Cao, Shenzhen (CN); Yuming Wu, Shanghai (CN); Jie Dai, Shanghai (CN); Yu Peng, Shanghai (CN); Heng Bu, Shenzhen (CN); Zipeng Zhang, Shanghai (CN)

(21) Appl. No.: 19/531,791

(22) Filed: Feb. 6, 2026

Related U.S. Application Data
(63) Continuation of application No. PCT/CN2024/079246, filed on Feb. 29, 2024.

(30) Foreign Application Priority Data
Aug. 7, 2023 (CN) 202310985953.7

(51) Int. Cl. G06F 9/48

(52) U.S. Cl. CPC G06F 9/4831

(57) ABSTRACT

An interrupt request balancing method and apparatus, and a computing device are provided. The computing device includes a plurality of processors, to obtain operating statuses of the plurality of processors. The computing device may set a processor that is in a non-idle state, whose operating frequency is within a preset frequency range, or whose load rate is less than a specified load rate in the plurality of processors to be used to process an IRQ other than a designated IRQ, and set a processor in another state to be used to process the designated IRQ.

### CROSS-REFERENCE TO RELATED APPLICATIONS

This application is a continuation of International Application No. PCT/CN2024/079246, filed on Feb. 29, 2024, which claims priority to Chinese Patent Application No.202310985953.7, filed on Aug. 7, 2023. The disclosures of the aforementioned applications are hereby incorporated by reference in their entireties.

### TECHNICAL FIELD

The present invention relates to the field of artificial intelligence technologies, and in particular, to an interrupt request balancing method and apparatus, and a computing device.

### BACKGROUND

Interrupt balance (interrupt balance) means that an interrupt request (interrupt request, IRQ) is appropriately allocated and managed in a computer system, to balance system performance and reliability. An interrupt balancing algorithm is configured in each mainstream operating system (operating system), so that an IRQ is allocated to different central processing units (CPUs) in a balanced manner for processing, thereby implementing a high degree of parallelism of the operating system. However, a CPU in an idle (idle) state may exist in a plurality of CPUs managed by the operating system. When the operating system allocates the IRQ according to the interrupt balancing algorithm, problems such as waking up a processor in an idle state, prolonging a latency of processing the IRQ by a processor at a high load rate, and increasing power consumption of a processor with a high frequency may occur, resulting in power consumption degradation and performance deterioration of a computer.

### SUMMARY

To resolve the foregoing problems, an embodiment of this application provides an interrupt request balancing method. Operating statuses of a plurality of processors of a computing device are detected, and a processor that is in a normal working state in the plurality of processors is used as a participating node. In this way, an IRQ can be allocated to the processor inside the participating node in a balanced manner. This avoids power consumption degradation and performance deterioration of a computing device caused by problems such as waking up a processor in an idle state, prolonging a latency of processing the IRQ by a processor at a high load rate, and increasing power consumption of a processor with a high frequency. In addition, this application further provides an interrupt request balancing apparatus and a computing device that correspond to the interrupt request balancing method.

Therefore, the following technical solutions are used in embodiments of this application.

According to a first aspect, an embodiment of this application provides an interrupt request IRQ balancing method. The interrupt request IRQ balancing method is executed by a computing device, and the computing device includes a plurality of processors. The method includes: obtaining operating statuses of the plurality of processors; and when a processor is not in a specified state, setting the processor to be used to process a designated IRQ, where the specified state includes one or more of a non-idle (idle) state, an operating frequency being within a preset frequency range, and a load rate being less than a specified load rate; or when the processor is in the specified state, setting the processor to be used to process an IRQ other than the designated IRQ.

In this implementation, there are usually a plurality of processors inside the computing device. A processor that is in a non-idle state, whose operating frequency is within a preset frequency range, or whose load rate is less than a specified load rate in the plurality of processors may be set to be used to process the IRQ other than the designated IRQ, and a processor in another state is set to be used to process the designated IRQ. The computing device does not allow a processor in an idle state to receive the IRQ other than the designated IRQ, to avoid power consumption degradation and performance deterioration of the computing device caused by problems such as waking up a processor in an idle state, prolonging a latency of processing the IRQ by a processor at a high load rate, and increasing power consumption of a processor with a high frequency.

In an implementation, the method further includes: allocating, according to an interrupt balancing algorithm in a balanced manner, the IRQ other than the designated IRQ to the processor in the specified state.

In this implementation, when running the interrupt balancing algorithm, the computing device may allocate, in a balanced manner, the received IRQ to the processor in the specified state, so that the processor in the specified state processes the IRQ in a balanced manner. This can keep performance such as a load rate, power consumption, and an operating frequency of each processor in the specified state the same, and can avoid power consumption degradation and performance deterioration of the computing device caused by problems such as waking up a processor in an idle state, prolonging a latency of processing the IRQ by a processor at a high load rate, and increasing power consumption of a processor with a high frequency.

In an implementation, the method further includes: when an operating status of the processor is switched from being in the specified state to being not in the specified state, setting the processor to be used to process the designated IRQ.

In this implementation, when determining that the operating status of the processor is switched from being in the specified state to being not in the specified state, the computing device may change a type of the IRQ processed by the processor, so that the processor processes the specified IRQ. In addition, this avoids power consumption degradation and performance deterioration of the computing device caused by problems such as waking up a processor in an idle state, prolonging a latency of processing the IRQ by a processor at a high load rate, and increasing power consumption of a processor with a high frequency.

In an implementation, when the operating status of the processor is switched from being not in the specified state to being in the specified state, the processor is set to be used to process the IRQ other than the designated IRQ.

In this implementation, when determining that the operating status of the processor is switched from being not in the specified state to being in the specified state, the computing device may change the type of the IRQ processed by the processor, so that more processors process the IRQ other than the specified IRQ. This can reduce a load rate, power consumption, a latency, and the like of each processor in the specified state.

In an implementation, the method further includes: in response to a quantity of IRQs received by the processor in the specified state exceeding a specified threshold, setting a part of processors not in the specified state to be used to process the IRQ other than the designated IRQ.

In this implementation, when the computing device detects that there are a large quantity of IRQs and a small quantity of processors in a specific state, a quantity of IRQs that need to be processed by each processor is large. Consequently, a latency in processing the IRQs by the processor is long. Therefore, the computing device may convert the part of processors not in the specified state into processors in the specified state, so that more processors process the IRQ other than the designated IRQ. This can reduce a latency of each processor in the operating state.

In an implementation, the method further includes: detecting an application scenario of the computing device; and adjusting a quantity of processors currently in the specified state based on a prestored relationship between quantities of processors in the specified state and various application scenarios of the computing device.

In this implementation, the computing device may be used in different application scenarios, for example, a communication scenario, an application program use scenario, a mobile office scenario, and a network browsing scenario. Different application scenarios generate different quantities of IRQs, and different quantities of processors in a specific state are required for processing the IRQs. Therefore, a designer may pre-train a relationship between different application scenarios and a quantity of processors in a specific state, and store the relationship between the different application scenarios and the quantity of processors in the specific state. After detecting a current application scenario, the computing device may adjust a quantity of processors in the specific state in the current application scenario, so that performance such as power consumption, a load rate, and a latency of the processors in the specific state is always in an optimal state.

According to a second aspect, an embodiment of this application provides an interrupt request IRQ balancing apparatus. The apparatus includes: a transceiver unit, configured to obtain operating statuses of a plurality of processors; and a processing unit, configured to: when a processor is not in a specified state, set the processor to be used to process a designated IRQ, where the specified state includes one or more of a non-idle state, an operating frequency being within a preset frequency range, and a load rate being less than a specified load rate; or when the processor is in the specified state, set the processor to be used to process an IRQ other than the designated IRQ.

In an implementation, the processing unit is further configured to allocate, according to an interrupt balancing algorithm in a balanced manner, the IRQ other than the designated IRQ to the processor in the specified state.

In an implementation, the processing unit is further configured to: when an operating status of the processor is switched from being in the specified state to being not in the specified state, set the processor to be used to process the designated IRQ.

In an implementation, the processing unit is further configured to: when the operating status of the processor is switched from being not in the specified state to being in the specified state, set the processor to be used to process the IRQ other than the designated IRQ.

In an implementation, the processing unit is further configured to: in response to a quantity of IRQs received by the processor in the specified state exceeding a specified threshold, set a part of processors not in the specified state to be used to process the IRQ other than the designated IRQ.

In an implementation, the processing unit is further configured to: detect an application scenario of the computing device; and adjust a quantity of processors currently in the specified state based on a prestored relationship between quantities of processors in the specified state and various application scenarios of the computing device.

According to a third aspect, an embodiment of this application provides a computing device. The computing device includes at least one memory and a plurality of processors. The plurality of processors include a main processor. The main processor is configured to execute instructions stored in the at least one memory, so that the computing device performs embodiments of possible implementations of the first aspect.

According to a fourth aspect, an embodiment of this application provides a computer-readable storage medium. The computer-readable storage medium stores a computer program. When the computer program is executed in a computer, the computer is enabled to perform embodiments of the possible implementations of the first aspect.

According to a fifth aspect, an embodiment of this application provides a computer program product. The computer program product stores instructions. When the instructions are executed by a computer, the computer is enabled to implement embodiments of the possible implementations of the first aspect.

### BRIEF DESCRIPTION OF DRAWINGS

The following briefly describes the accompanying drawings that need to be used in the descriptions of embodiments or the conventional technology.

FIG. 1(a) is a diagram of a solution for allocating an IRQ by an operating system in a related technology;

FIG. 1(b) is a diagram of another solution for allocating an IRQ by an operating system in a related technology;

FIG. 1(c) is a diagram of another solution for allocating an IRQ by an operating system in a related technology;

FIG. 2 is a diagram of a solution for allocating an IRQ by an operating system according to an embodiment of this application;

FIG. 3 is a diagram of an architecture of a computing device according to an embodiment of this application;

FIG. 4 is a diagram of an architecture of an operating system according to an embodiment of this application;

FIG. 5 is a control flowchart of each module of an operating system according to an embodiment of this application;

FIG. 6 is a schematic flowchart of an IRQ balancing method according to an embodiment of this application;

FIG. 7(a) is a data diagram of a simulation experiment of quantities of times of core interruption in different IRQ allocation solutions according to an embodiment of this application;

FIG. 7(b) is a data diagram of a simulation experiment of latencies of processing an IRQ by a core in different IRQ allocation solutions according to an embodiment of this application;

FIG. 7(c) is a data diagram of a simulation experiment of time for IRQ migration and time for core migration according to an embodiment of this application; and

FIG. 8 is a diagram of a structure of an IRQ balancing apparatus according to an embodiment of this application.

### DESCRIPTION OF EMBODIMENTS

The following describes the technical solutions in embodiments of this application with reference to the accompanying drawings in embodiments of this application.

The term “and/or” in this specification describes an association relationship between associated objects and indicates that three relationships may exist. For example, A and/or B may indicate the following three cases: Only A exists, both A and B exist, and only B exists. The character “/” in this specification indicates an “or” relationship between the associated objects. For example, A/B indicates A or B.

In the specification and claims of this application, the terms “first”, “second”, and the like are used for distinguishing between different objects, but are not used for describing a particular order of the objects. For example, a first response message, a second response message, and the like are used for distinguishing between different response messages, but are not used for describing a particular order of the response messages.

In embodiments of this application, the word “example”, “for example” or the like is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

In the descriptions of embodiments of this application, unless otherwise specified, “a plurality of” means two or more. For example, a plurality of processing units are two or more processing units, and a plurality of elements are two or more elements.

An IRQ is used by hardware to send, to an operating system, a request to interrupt or cancel a current operation. Generally, when an external device needs to send an interrupt signal, the external device changes a level of a terminal pin connected to a generic interrupt controller (GIC) or an advanced programmable interrupt controller (APIC). When identifying that a level of an interrupt signal line changes, the GIC or the APIC sends an interrupt signal to a CPU. After receiving the interrupt signal, the CPU immediately stops a current execution flow and jumps to an interrupt handler. Therefore, the interrupt signal sent by the external device to the GIC or the APIC, or sent by the GIC or the APIC to the CPU may be referred to as an IRQ.

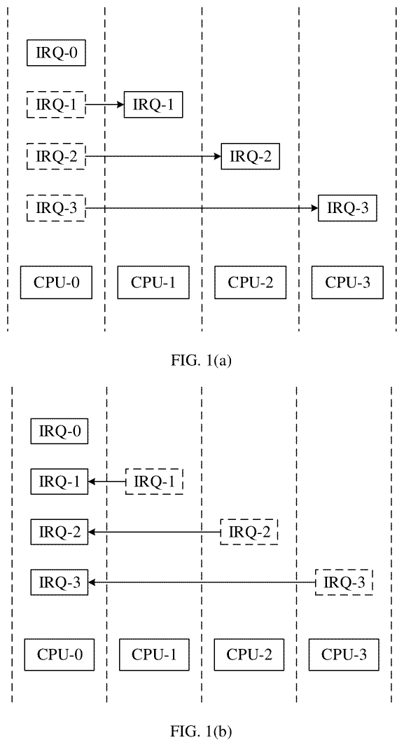

As shown in FIG. 1(a), an operating system may run four CPUs: CPU-0, CPU-1, CPU-2, and CPU-3. The operating system receives four IRQs: IRQ-0, IRQ-1, IRQ-2, and IRQ-3. In a normal case, the operating system is in a performance mode (performance mode). After running an interrupt balancing algorithm, the operating system may evenly allocate a plurality of IRQs to different CPUs, so that the operating system achieves high parallelism. To be specific, the operating system allocates IRQ-0 to CPU-0, allocates IRQ-1 to CPU-1, allocates IRQ-2 to CPU-2, and allocates IRQ-3 to CPU-3.

However, in a process in which the operating system allocates the IRQs, operations such as periodically collecting statistics on a quantity of IRQs and a load rate of each CPU, calculating interrupt affinity of an IRQ allocated to each CPU, and interrupting migration need to be performed. Consequently, costs of each reallocation of the operating system are high. In addition, when the operating system evenly allocates the IRQs, problems such as waking up a processor in an idle state, prolonging a latency of processing the IRQ by a processor at a high load rate, and increasing power consumption of a processor with a high frequency may occur, resulting in power consumption degradation and performance deterioration of a computing device.

As shown in FIG. 1(b), an operating system may run four CPUs: CPU-0, CPU-1, CPU-2, and CPU-3. The operating system receives four IRQs: IRQ-0, IRQ-1, IRQ-2, and IRQ-3. When the operating system is in a power save mode (power save mode), a background daemon thread may be started, and a plurality of IRQs are allocated to one or a few CPUs in a centralized manner, to avoid waking up a CPU in an idle state. To be specific, the operating system may allocate IRQ-1 of CPU-1 to CPU-0, allocate IRQ-2 of CPU-2 to CPU-0, and allocate IRQ-3 of CPU-3 to CPU-0.

However, in a process in which the operating system allocates the IRQs, costs of each reallocation performed by the operating system are high. In addition, the operating system allocates a plurality of IRQs to CPU-0. As a result, CPU-0 is at a high load rate. Because CPU-0 needs to process a large quantity of IRQs, a latency of processing the IRQs by CPU-0 is long. As a result, the operating system cannot perform dynamic adjustment in real time.

As shown in FIG. 1(c), an operating system may run four CPUs: CPU-0, CPU-1, CPU-2, and CPU-3. The operating system receives four IRQs: IRQ-0, IRQ-1, IRQ-2, and IRQ-3. It is assumed that CPU-0, CPU-1, and CPU-3 are in an online (online) mode, and CPU-2 is in an offline (offline) mode. The offline mode means that CPU-2 may enter a sleep mode or be unplugged. When CPU-2 switches from the online mode to the offline mode, the operating system may migrate IRQs bound to CPU-2 one by one to a CPU in a working state. When CPU-2 switches from the offline mode to the online mode, the operating system may migrate, to CPU-2 one by one, IRQs bound to another CPU.

However, each time a CPU switches between the offline mode and the online mode, the CPU needs to migrate, to another CPU, an IRQ bound to the CPU, or migrate, to the CPU, an IRQ bound to another CPU. If a large quantity of IRQs are migrated, the CPU cannot quickly switch from the offline mode to the online mode or switch from the online mode to the offline mode. As a result, a frame freezing problem occurs in the operating system.

To resolve a defect in the related technology, embodiments of this application provide an IRQ balancing method and a computing device. Generally, the computing device includes a plurality of processors, to obtain operating statuses of the plurality of processors. When a processor is in a specified state, the computing device sets the processor to be used to process an IRQ other than a designated IRQ, and the computing device sets, based on an operating status of the processor, the processor to be used to process the designated IRQ. The specified state includes one or more of a non-idle state, an operating frequency being within a preset frequency range, and a load rate being less than a specified load rate.

In embodiments of this application, the computing device may construct processors in the specified state into a participating node (participating node). The computing device may run an interrupt balancing algorithm, and allocate received IRQs to the processors in the participating node in a balanced manner, so that all the processors inside the participating node have equal permission, and can equally receive and process the IRQs. After receiving the IRQ, the computing device allocates the IRQ to a processor inside the participating node for processing by default. This can avoid a long latency in processing the IRQ caused by resource contention of a single-core processor outside the participating node. In addition, this can avoid power consumption degradation and performance deterioration of a computing device caused by problems such as waking up a processor in an idle state, prolonging a latency of processing the IRQ by a processor at a high load rate, and increasing power consumption of a processor with a high frequency. The plurality of processors inside the participating node may process the IRQ in a balanced manner. This can keep performance such as a load rate, power consumption, and an operating frequency of each processor in the specified state the same, and can avoid power consumption degradation and performance deterioration of the computing device caused by problems such as waking up a processor in an idle state, prolonging a latency of processing the IRQ by a processor at a high load rate, and increasing power consumption of a processor with a high frequency.

In addition, a light interrupt request balancer (light IRQ balancer) may be designed inside the participating node. The light interrupt request balancer is used for detecting performance parameters such as an idle state, a load rate, and an operating frequency of each processor, and system parameters such as an application scenario of the computing device and a quantity of processors, and may dynamically adjust the processor inside the participating node, and lightly migrate a processor out of or into the participating node. The participating node optimizes the processor inside the participating node, so that the IRQ can be better processed.

The participating node is a node that is obtained through division in software, and is obtained through division based on a feature and a function of a processor that processes the IRQ other than the designated IRQ. In embodiments of this application, the processor inside the participating node may process the IRQ other than the designated IRQ. The processor outside the participating node may process the designated IRQ or does not process an IRQ.

The processor inside the participating node is a processor in the specified state, and the processor outside the participating node is a processor not in the specified state. “Migrating out of the participating node” means that an operating status of the processor is switched from being in the specific state to being not in the specific state. “Migrating into the participating node” means that the operating status of the processor is switched from being not in the specific state to being in the specific state. Therefore, the following uses “participating node” to describe the technical solutions of this application, so that a reader can better understand the technical solutions of this application.

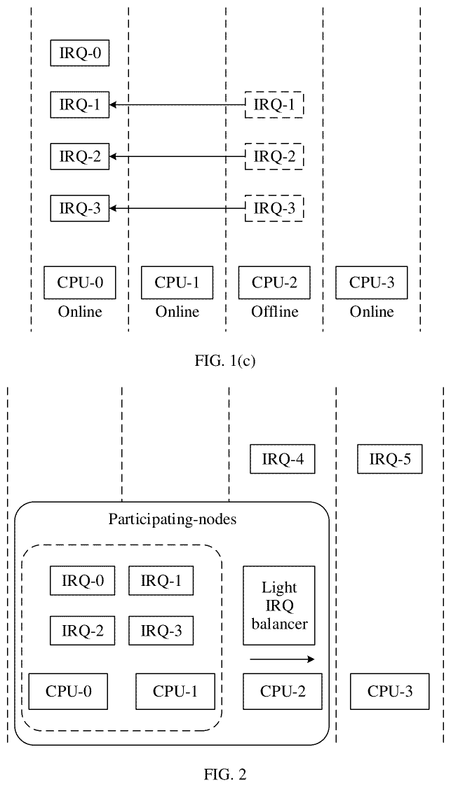

As shown in FIG. 2, an operating system may run four CPUs: CPU-0, CPU-1, CPU-2, and CPU-3. The operating system receives six IRQs: IRQ-0, IRQ-1, IRQ-2, IRQ-3, IRQ-4, and IRQ-5. CPU-0, CPU-1, and CPU-2 are located inside the participating node. CPU-3 is located outside the participating node. It is assumed that IRQ-0, IRQ-1, IRQ-2, and IRQ-3 are allocated to the inside of the participating node, and IRQ-4 and IRQ-5 are allocated to the outside of the participating node. The light interrupt request balancer inside the participating node may enable CPU-2 to be lightly migrated out of or into the participating node.

In a case, when the operating system is in the performance mode, the light interrupt request balancer detects that CPU-2 is in an idle state, and may migrate CPU-2 out of the participating node. In this case, an IRQ inside the participating node is not routed to CPU-2 for processing. This can avoid power consumption degradation and performance deterioration of the computing device caused by problems such as waking up a CPU in an idle state, prolonging a latency of processing the IRQ by a CPU at a high load rate, and increasing power consumption of a CPU with a high frequency.

In another case, when the operating system is in the power save mode, the light interrupt request balancer may sense a status of a processor, and enable CPU-2 to enter the participating node. The participating node may run the interrupt balancing algorithm, to allocate some IRQs to CPU-2, and reduce a quantity of IRQs that need to be processed by a CPU inside an original participating node, to avoid a long latency of processing the IRQ by the CPU inside the original participating node, and therefore avoid that the operating system cannot perform real-time dynamic adjustment.

In another case, when the operating system in a low-power state with wake-up enabled or a hotplug (hotplug) state, the light interrupt request balancer may lightly migrate, out of the participating node, CPU-2 that enters the sleep state or is unplugged, or migrate, into the participating node, CPU-2 that is woken up from the sleep state or is plugged in. When the operating system determines to migrate CPU-2 out of the participating node, the operating system allocates an IRQ to another CPU in the participating node, and does not need to allocate an IRQ to CPU-2. In comparison with the related technology in which the operating system migrates a plurality of IRQs bound to one CPU to another CPU one by one, in this application, CPU-2 only needs to be migrated out of the participating node, to quickly switch CPU-2 from the online mode to the offline mode.

Similarly, when the operating system determines to migrate CPU-2 into the participating node, the operating system re-detects CPUs inside the participating node in an IRQ allocation process, and delivers IRQs to the CPUs in the participating node in a balanced manner. In comparison with the related technology in which the operating system migrates a plurality of IRQs bound to another CPU to CPU-2 one by one, in this application, CPU-2 only needs to be migrated into the participating node, to quickly switch CPU-2 from the offline mode to the online mode.

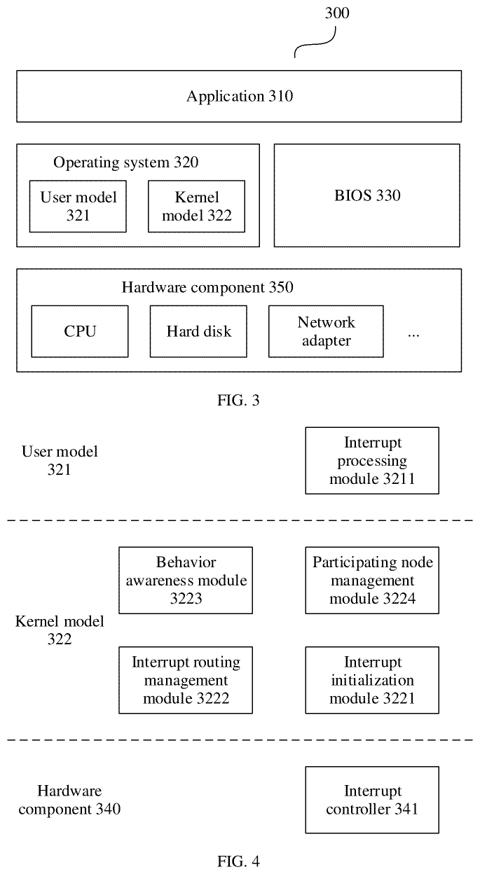

FIG. 3 is a diagram of an architecture of a computing device according to an embodiment of this application. As shown in FIG. 3, the computing device 300 includes an application 310, an operating system 320, a basic input/output system (BIOS) 330, and a hardware component 340.

The application 310 is a computer program that completes one or more specific tasks. The application 310 is installed in the operating system 320, and may interact with a user, and create one or more execution tasks after receiving an operation instruction of the user. Each application 310 is run in an independent process and has independent address space.

The operating system 320 is a set of interrelated system software programs that manage and control computer operations, use and run hardware and software resources, and provide public services to organize user interaction. The operating system 320 may schedule resources of the computing device 300, including software and hardware devices, data information, and the like. The computer operating system may be used, so that working intensity of manual resource allocation can be reduced, a degree of operation intervention of a user on a computer can be reduced, and intelligent working efficiency of the computer can be greatly improved. The operating system 320 may be a Linux system real-time operating system or the like.

The BIOS 330 is an industry standard firmware interface. The BIOS 330 is a group of programs that are fixed on a read-only memory (ROM) chip on a mainboard in the computer, and store a most important basic input/output program, a self-check program after startup, and a system self-start program of the computer. A main function of the BIOS 330 is to provide most bottom-layer and most direct hardware setting and control for the computer. The BIOS 330 does not directly control the hardware component 340, but provides an abstraction layer and directly controls the hardware component 340.

The hardware component 340 includes various hardware of the computing device 300, such as a CPU, a hard disk, a network adapter, and an interrupt controller. The hardware component 340 is configured to support normal working of the computing device 300.

Memory space in which the operating system 320 runs may be divided into two parts: kernel space and user space. The user space is space in which user program code is run. The kernel space is space in which kernel code is run. When a process is run in the user space, the process is in “a user model (user model)”. A process in a user model 321 is also referred to as a user model process. When a process is run in the kernel space, the process is in “a kernel model (kernel model)”. A process in a kernel model 322 is also referred to as a kernel model process.

In a design of the operating system 320, the user model 321 is a non-privileged execution state. A kernel does not allow code in this state to perform potentially dangerous operations, such as writing system configuration files, killing processes of other users, and restarting the system. The kernel model 322 is a privileged execution state. The kernel may allow code in this state to perform any operation.

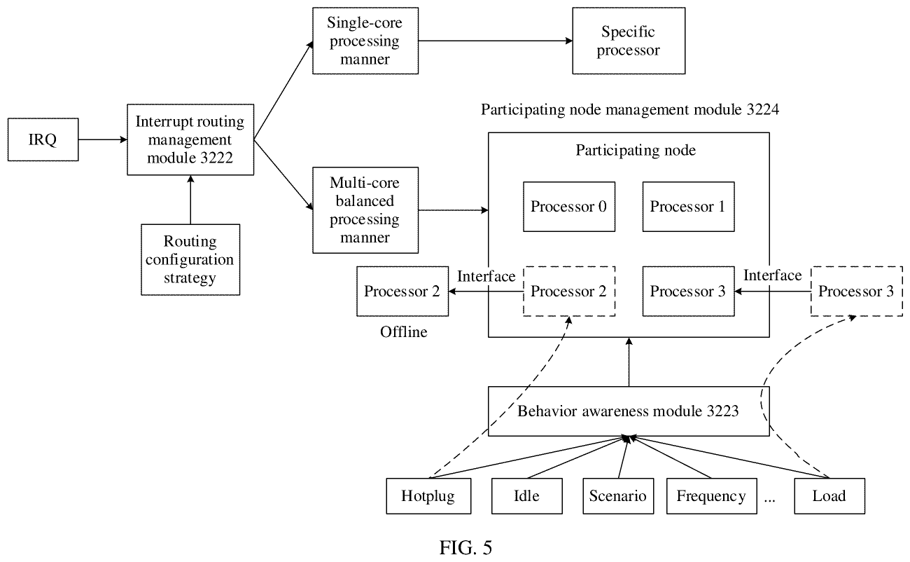

As shown in FIG. 4, the operating system 320 obtains, through division in the kernel model 322 based on an executed function, an interrupt initialization module 3221, an interrupt routing management module 3222, a behavior awareness module 3223, and a participating node management module 3224, and obtains an interrupt processing module 3211 through division in the user model 321. The interrupt initialization module 3221, the interrupt routing management module 3222, the behavior awareness module 3223, the participating node management module 3224, and the interrupt processing module 3211 may all be implemented by using software, or may be implemented by using hardware, or may be implemented by using a combination of software and hardware.

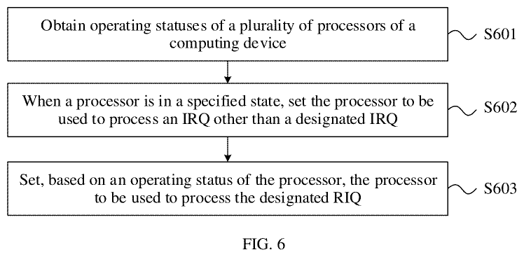

The following describes the technical solutions of this application by using each execution module of the operating system 320 and with reference to a control flowchart shown in FIG. 5.

The hardware component 340 includes an interrupt controller 341. The interrupt controller 341 may be hardware such as a GIC or an APIC. The GIC is an interrupt controller based on an advanced reduced instruction set computing (RISC) machine (ARM) architecture. In a multi-core processor system, the GIC may coordinate interrupt signal processing between a plurality of processor cores, and provide a consistent interrupt management and allocation mechanism, to ensure that the system can efficiently run and reliably respond to external events and devices. The APIC is an interrupt controller based on an extended 86 (extended 86) architecture. The APIC is configured to process and distribute an interrupt signal, to ensure that the interrupt signal is correctly routed to a corresponding processor core or device.

The interrupt initialization module 3221 is configured to initialize the interrupt controller 234, to ensure that the operating system 320 can accurately and reliably capture and process an interrupt event. In addition, the interrupt initialization module 3221 may further sniff a routing mode of the interrupt routing management module 3222, detect a type of routing mode indicated by hardware, and correspondingly adjust a software policy.

After receiving an IRQ, the interrupt routing management module 3222 may select an IRQ routing manner based on interrupt configuration information configured by the user. The IRQ routing manner may be classified into a single-core processing routing manner and a multi-core balanced processing routing manner. The single-core processing routing manner indicates that the IRQ is allocated to a specific processor for processing. The multi-core balanced processing routing manner indicates that the IRQ is allocated to a processor row inside the participating node for processing.

In embodiments of this application, when registering an interrupt, the operating system 320 associates an interrupt handler with a specific interrupt signal. The operating system 320 may divide processors into a specific processor and a general processor based on attributes of IRQs processed by the processors. The specific processor is a processor that processes a special IRQ like a high-priority IRQ or an emergency IRQ. The general processor is a processor that processes an IRQ other than the special IRQ. The operating system 320 may construct general processors into a participating node, so that the general processors can equally receive and process the IRQ. The operating system 320 may receive interrupt configuration information of the IRQ from the user, and classify the IRQ routing manner into the single-core processing routing manner and the multi-core balanced processing routing manner, to select an appropriate routing manner for transmitting the IRQ.

In a case, when determining that the IRQ is a special IRQ, the interrupt routing management module 3222 may migrate the IRQ to a specific processor in the single-core processing routing manner, so that the specific processor specially processes the special IRQ. Because the special IRQ can be processed only by the specific processor, the specific processor receives and processes the special IRQ regardless of a state of the specific processor.

In another case, when determining that the IRQ is not a special IRQ, the interrupt routing management module 3222 migrates the IRQ to the participating node by default in the multi-core balanced processing routing manner. The participating node runs an interrupt balancing algorithm, and allocates the received IRQ to a processor inside the participating node in a balanced manner.

The behavior awareness module 3223 may periodically detect parameters of target devices such as a processor, a hard disk, a clock or a timer, an external device, and an external controller through a light IRQ balancer, to determine whether the processor is in a state of being woken up from sleep or in a hotplug state, whether the processor is in an idle state, whether an operating frequency of the processor is within a preset frequency range, whether a load rate of the processor is less than a specified load rate, whether the processor processes a high-priority IRQ, whether the processor processes an emergency IRQ, an application scenario in which the computing device 300 is located, and the like. The application scenario may be a communication scenario, an application use scenario, a mobile office scenario, a network browsing scenario, or the like.

The participating node management module 3224 usually runs the interrupt balancing algorithm, and allocates a plurality of received IRQs to processors inside the participating node in a balanced manner, so that the processors inside the participating node equally process the IRQs, working statuses of the processors are the same, and abnormal conditions such as a high load rate or a high frequency of an individual processor do not occur. The participating node management module 3224 detects whether a status of the processor changes, and may optimize the processors inside the participating node, so that the participating node better processes the IRQs. For example, when a processor inside the participating node is in an idle state, the participating node management module 3224 may migrate the processor in the idle state inside the participating node out of the participating node, to avoid power consumption degradation and performance deterioration of the computing device caused by problems such as waking up the processor in the idle state, prolonging a latency of processing the IRQ by a processor at a high load rate, and increasing power consumption of a processor with a high frequency. For another example, when a processor inside the participating node is at a high load rate, the participating node management module 3224 may migrate a specified quantity of processors outside the participating node into the participating node, to reduce a load rate inside the participating node. For another example, when an operating frequency of a processor inside the participating node exceeds a preset frequency range, the participating node management module 3224 may migrate a processor whose operating frequency is not within a specified range out of the participating node, to avoid power consumption degradation of the operating system due to a large difference between operating frequencies of the processors inside the participating node.

The interrupt processing module 3211 may import an IRQ from the kernel model 322 to the user model 321 based on a routing status of the IRQ, so that a processor invoked by using the user model 321 processes the IRQ.

In embodiments of this application, the operating system 320 may construct a part of the processors into the participating node based on a configuration item of the user. The participating node may run the interrupt balancing algorithm, and allocate the received IRQs to processors in the participating node in a balanced manner, so that all processors inside the participating node have equal permission, and can equally receive and process the IRQs. The participating node may receive information about a component that participates in processing the IRQ, dynamically adjust a processor inside the participating node, and lightly migrate a processor out of or into the participating node. The participating node optimizes the processor inside the participating node, so that the IRQ can be better processed.

The foregoing describes the computing device 300 provided in embodiments of this application. The following describes, based on the foregoing content, an IRQ balancing method provided in embodiments of this application.

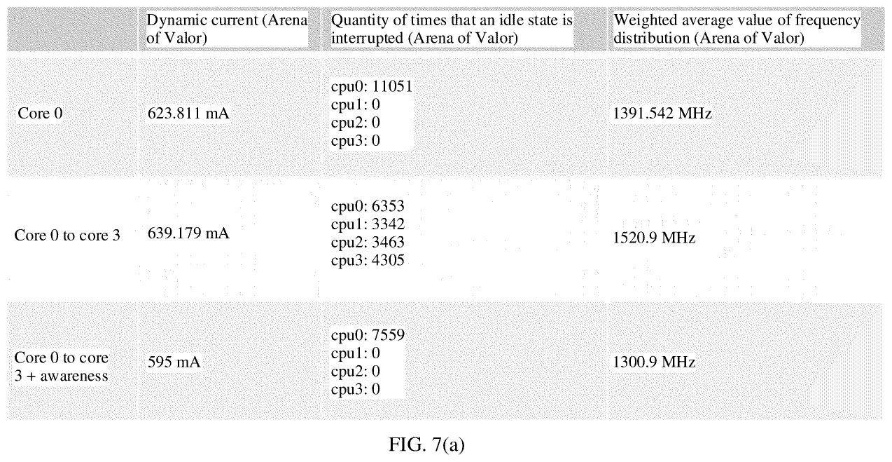

FIG. 6 is a flowchart of an IRQ balancing method according to an embodiment of this application. The method may be performed by the operating system 320. As shown in FIG. 6, the IRQ balancing method may include the following steps.

S601: The operating system 320 obtains operating statuses of a plurality of processors of the computing device 300.

The computing device 300 may be a terminal device like a server, a desktop computer, or a portable notebook computer. The computing device 300 generally includes the plurality of processors, and the plurality of processors respectively undertake key tasks of performing computation and controlling computer operations. The processor may be a component having a computing function, for example, a CPU, a graphics processing unit (GPU), or an extensible processing unit (XPU).

In a case, when there is only one component having a computing function inside the computing device 300, the computing device 300 may divide resources of the component having the computing function into a plurality of computing units based on the computing function. In this case, the processor may be a computing unit.

In another case, when the computing device 300 is a computing cluster including a plurality of servers, one server may be used as one processor.

S602: When a processor is in a specified state, the operating system 320 sets the processor to be used to process an IRQ other than a designated IRQ.

S603: The operating system 320 sets, based on an operating status of the processor, the processor to be used to process the designated IRQ.

The operating system 320 may detect performance parameters such as an idle state, a load rate, and an operating frequency of each processor, and system parameters such as an application scenario of the computing device and a quantity of processors by using a light IRQ balancer. The operating system 320 may construct, based on performance parameters of the processors, a participating node by using processors which are in a non-idle state, whose operating frequencies are within a preset frequency range, whose load rates are less than a specified load rate, or the like. Processors in other states are located outside the participating node. The participating node may run an interrupt balancing algorithm, and allocates received IRQs to a part of the processors inside the participating node in a balanced manner. The part of the processors inside the participating node have equal permission, and can equally receive and process the IRQs.

Optionally, the operating system 320 may divide the processors into a specific processor and a general processor based on attributes of IRQs processed by the processors. The specific processor is configured to process a special IRQ like a high-priority IRQ or an emergency IRQ. The general processor is configured to process an IRQ other than the special IRQ. The operating system 320 may construct general processors into a participating node, and transmit a non-special IRQ to the participating node by default. The operating system 320 may set the specific processor outside the participating node, and use the specific processor as a single-core processor to specially receive and process the special IRQ.

In this embodiment of this application, in a process of constructing the participating node, the operating system 320 may detect statuses of the processors, filter out a processor that is in an idle state, is at a high load rate, processes the special IRQ, or is in a state of being woken up from sleep or in a hot plug state, and construct the other processors into a participating node, so that the processors inside the participating node can randomly process the IRQ.

The participating node may be provided with a light interface, so that a processor inside the participating node can exit the participating node, and a processor outside the participating node can join the participating node. The light interface is designed in a simplified, flexible, medical, and efficient design manner, to design a concise and effective communication and interaction manner. The light interface has a low latency feature, and a processor can quickly pass through the light interface, to quickly change the processor inside the participating node.

In embodiments of this application, after receiving an IRQ, the operating system 320 selects an appropriate routing manner for the IRQ based on interrupt configuration information, and migrates, in the appropriate routing manner, the IRQ to a corresponding processor for processing. The IRQ routing manner may be classified into a single-core processing routing manner and a multi-core balanced processing routing manner. The single-core processing routing manner indicates that the IRQ is allocated to a specific processor for processing. The multi-core balanced processing routing manner indicates that the IRQ is allocated to a processor row inside the participating node for processing.

The interrupt configuration information is information pre-stored by a user, and generally includes importance of the IRQ, consistency of input/output (I/O) data storage, and the like. In a case, after receiving the IRQ, the operating system 320 detects that the importance of the IRQ matches importance of the interrupt configuration information, and may select the single-core processing routing manner to migrate the IRQ to a corresponding specific processor. On the contrary, the operating system 320 selects the multi-core balanced processing routing manner to migrate the IRQ to the participating node.

The operating system 320 may periodically detect parameters of target devices such as a processor, a hard disk, a clock or a timer, an external device, and an external controller through a light IRQ balancer, to determine whether the processor is in a state of being woken up from sleep or in a hotplug state, whether the processor is in an idle state, whether an operating frequency of the processor is within a preset frequency range, whether a load rate of the processor is less than a specified load rate, whether the processor processes a high-priority IRQ, whether the processor processes an emergency IRQ, an application scenario in which the computing device 300 is located, and the like.

The operating system 320 modifies a processor inside the participating node based on whether a status of the processor changes, so that the participating node can better process the IRQ. In a case, when determining that a processor inside the participating node is in an idle state, the operating system 320 may migrate the processor in the idle state out of the participating node through the light interface, to avoid power consumption degradation and performance deterioration of the computing device caused by problems such as waking up the processor in the idle state, prolonging a latency of processing the IRQ by a processor at a high load rate, and increasing power consumption of a processor with a high frequency.

Optionally, when detecting that a processor that exits the participating node switches from an idle state to a working state, the operating system 320 may migrate the processor into the participating node through the light interface. The operating system 320 enables the processor that exits the participating node to join the participating node again, to reduce a load rate of the processor inside the participating node, and avoid a case in which the operating system 320 cannot perform real-time dynamic adjustment due to a long latency of processing the IRQ by the processor.

In another case, when the operating system 320 determines that a processor inside the participating node is in a low-power state with wake-up enabled or a hotplug state, the processor in the low-power state with wake-up enabled or the hotplug state may be offline or online at any time, and consequently, working statuses of other processors inside the participating node are unstable. The operating system 320 detects statuses of the processors, and may migrate, out of the participating node through the light interface, the processor that enters the sleep state or is unplugged, or migrate, into the participating node through the light interface, the processor that is woken up from the sleep state or is plugged in, to avoid impact of the processor in the low-power state with wake-up enabled or the hotplug state on working statuses of other processors inside the participating node.

In addition, when the processor is suddenly plugged into the computing device 300 or is woken up from the sleep state, the computing device 300 needs to allocate an IRQ to the plugged-in processor as soon as possible, to increase a response speed of the processor. Similarly, when the processor is suddenly unplugged from the computing device or enters the idle state, the computing device 300 needs to allocate, to another processor as soon as possible, an IRQ bound to the offline processor, to avoid a computing device breakdown caused by sudden offline of the processor. In embodiments of this application, when determining that there is a processor inside the participating node migrated out of the participating node or there is a processor migrated into the participating node, the operating system 320 may modify an IRQ allocation solution. The operating system 320 detects the processors inside the participating node, and allocates IRQs to the processors inside the participating node in a balanced manner. In comparison with the related technology, in this case, the operating system 320 converts an IRQ migration operation into a processor migration operation, so that a processor in a low-power state with wake-up enabled or a hotplug state can quickly switch from an offline mode to an online mode or from the online mode to the offline mode.

In another case, when detecting that a processor inside the participating node is at a high load rate, the operating system 320 may migrate, into the participating node through the light interface, a processor outside the participating node. The operating system 320 increases a quantity of processors inside the participating node, to reduce a quantity of IRQs processed by each processor, and switch processors inside the participating node from a high load rate to a normal state or a low load rate.

In another case, when detecting that an operating frequency of a processor inside the participating node exceeds a preset frequency range, the operating system 320 may migrate, through the light interface, a processor in a high frequency state or a low frequency state out of the participating node, or disable the processor in the high frequency state or the low frequency state, to implement frequency modulation for a plurality of processors in the participating node. The operating system 320 disables a processor whose operating frequency is excessively high or excessively low inside the participating node, to keep the processors inside the participating node within a specified range, so that the plurality of processors in the participating node can concurrently process the IRQs, and distribution uniformity of operating frequencies of the processors inside the participating node is improved.

In another case, when detecting that a processor inside the participating node is dedicated to processing a special IRQ like a high-priority IRQ or an emergency IRQ, the operating system 320 may migrate the processor out of the participating node through the light interface, to avoid continuing to receive another IRQ by the processor in the participating node, and affect processing progress of the special IRQ.

In another case, when detecting an application scenario in which the computing device 300 is located, the operating system 320 may migrate, into the participating node through the light interface based on a preset quantity of processors inside the participating node corresponding to each scenario, a specified quantity of processors outside the participating node, or migrate a specified quantity of processors inside the participating node out of the participating node through the light interface, to keep a quantity of processors inside the participating node at a quantity of processors corresponding to the scenario in which the computing device 300 is located.

The computing device may be used in different application scenarios, for example, a communication scenario, an application program use scenario, a mobile office scenario, and a network browsing scenario. Different application scenarios generate different quantities of IRQs, and different quantities of processors in a specific state are required for processing the IRQs. Therefore, a designer may pre-train a relationship between different application scenarios and a quantity of processors in a specific state, and store the relationship between the different application scenarios and the quantity of processors in the specific state. After detecting a current application scenario, the computing device may adjust a quantity of processors in the specific state in the current application scenario, so that performance such as power consumption, a load rate, and a latency of the processors in the specific state is always in an optimal state.

In embodiments of this application, the operating system constructs a participating node by using a part of the plurality of processors of the computing device. The participating node may run the interrupt balancing algorithm, so that processors inside the participating node can process the IRQs in a balanced manner. A processor outside the participating node may not process an IRQ or may process a special IRQ. After receiving an IRQ, the operating system may allocate the IRQ to a processor inside the participating node by default, to a long latency of processing the IRQ by the processor inside the participating node due to resource contention caused by a processor outside the participating node. The plurality of processors inside the participating node may process the IRQ in a balanced manner, to avoid a single processor from processing the IRQ at a high load, thereby improving performance of the operating system and reducing power consumption of the operating system.

In addition, the operating system detects whether a status of a processor changes, and migrates, out of the participating node, a processor that is in a special case like in an idle state, with an operating frequency not within a preset frequency range, at a load rate not less than a specified load rate, or processing a special IRQ, and migrates a part of the processors into the participating node when the processors inside the participating node are at a high load rate, to optimize the processors inside the participating node, so that the processors inside the participating node better processes the IRQ.

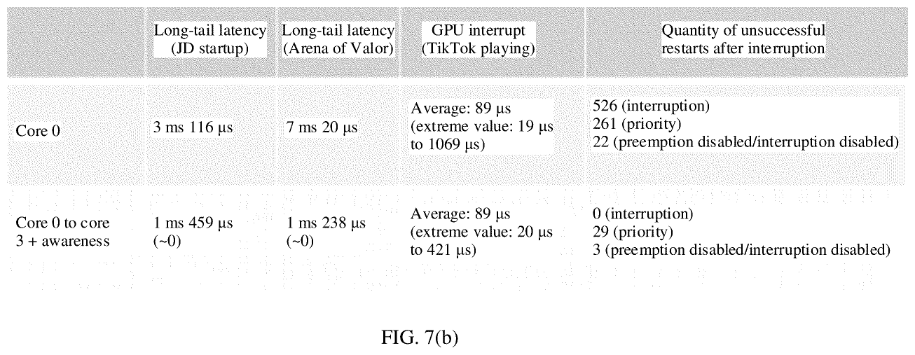

FIG. 7(a) to FIG. 7(c) are data diagrams of an experiment performed when the protection solution of this application is applied to a computing device.

As shown in FIG. 7(a), the computing device may run four cores (cores): core 0, core 1, core 2, and core 3. Data in a first row indicates that core 0 is in an idle state, and core 1, core 2, and core 3 are in a working state. When the computing device runs an “Arena of Valor” application, core 0 (namely, cpu 0) being in an idle state is interrupted 11051 times. A weighted average value of frequency distribution of the four cores is 1391.542 MHz.

Data in a second row indicates that core 0, core 1, core 2, and core 3 are in an idle state. When the computing device runs Arena of Valor, core 0 (namely, cpu0) being in the idle state is interrupted 6353 times, core 1 (namely, cpu 1) being in the idle state is interrupted 3342 times, core 2 (namely, cpu 2) being in the idle state is interrupted 3463 times, and core 3 (namely, cpu 3) being in the idle state is interrupted 4305 times. A weighted average value of frequency distribution of core 0, core 1, core 2, and core 3 is 1520.9 MHz. It can be learned that although a quantity of times that a single core being in the idle state is interrupted is reduced, a fluctuation of operating frequencies of the four cores increases.

Data in a third row indicates that there are core 0, core 1, core 2, and core 3 inside the participating node, and a core in the idle state inside the participating node can be migrated out of the participating node. When the computing device runs the Arena of Valor, an IRQ generated is processed by a core inside the participating node. Core 0 (namely, cpu0) being in the idle state is interrupted 7559 times. A weighted average value of frequency distribution of the cores inside the participating node is 1300.9 MHz. It can be learned that a quantity of times that the cores inside the participating node being in the idle state is interrupted is reduced, and a fluctuation of operating frequencies of a plurality of cores inside the participating node is reduced.

As shown in FIG. 7(b), the computing device may run four cores: core 0, core 1, core 2, and core 3. Data in a first row indicates that there is only core 0 inside the participating node, and no core is migrated out of or into the participating node. When the computing device runs a “JD” application, a latency of processing an IRQ by core 0 inside the participating node is 3 ms 116 μs. When the computing device runs the “Arena of Valor” application, a latency of processing an IRQ by core 0 inside the participating node is 7 ms 20 μs. When the computing device plays “TikTok”, an average latency of processing an IRQ by core 0 inside the participating node is 89 μs (with an extreme value in a range from 19 μs to 1069 μs).

Data in a second row indicates that there is core 0, core 1, core 2, and core 3 inside the participating node, and a core is migrated out of or into the participating node. When the computing device runs a “JD” application, a latency of processing an IRQ by core 0 inside the participating node is 1 ms 459 μs. When the computing device runs the “Arena of Valor” application, a latency of processing an IRQ by core 0 inside the participating node is 1 ms 238 μs. When the computing device plays “TikTok”, an average latency of processing an IRQ by core 0 inside the participating node is 89 μs (with an extreme value in a range from 20 μs to 421 μs). It can be learned that the latency of processing the IRQ by core 0 inside the participating node is greatly reduced.

As shown in FIG. 7(c), a first row indicates that when a working state of one core is switched to a sleep state, time consumed for migrating 100 IRQs bound to the core to another core is 11000 ns. A second row indicates that time consumed for migrating one core out of the participating node is 0.5 ns. It can be learned that the time consumed for migrating one core is greatly reduced in comparison with the time consumed for migrating 100 IRQs.

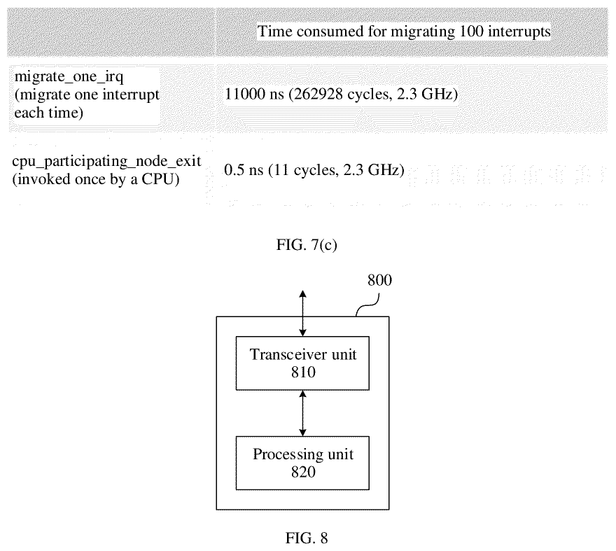

FIG. 8 is a diagram of a structure of an IRQ balancing apparatus according to an embodiment of this application. As shown in FIG. 8, the IRQ balancing apparatus 800 may be divided into a transceiver unit 810 and a processing unit 820 based on an execution function. A specific implementation process of the IRQ balancing apparatus 800 is described as follows.

The transceiver unit 810 is configured to obtain operating statuses of a plurality of processors. The processing unit 820 is configured to set a processor to be used to process a designated IRQ when the processor is not in a specified state. The specified state includes one or more of a non-idle state, an operating frequency being within a preset frequency range, and a load rate being less than a specified load rate. The processing unit 820 is further configured to set a processor to be used to process an IRQ other than the designated IRQ when the processor is in the specified state.

In an implementation, the processing unit 820 is further configured to allocate, according to an interrupt balancing algorithm in a balanced manner, the IRQ other than the designated IRQ to the processor in the specified state.

In an implementation, the processing unit 820 is further configured to: when an operating status of the processor is switched from being in the specified state to being not in the specified state, set the processor to be used to process the designated IRQ.

In an implementation, the processing unit 820 is further configured to: when the operating status of the processor is switched from being not in the specified state to being in the specified state, set the processor to be used to process the IRQ other than the designated IRQ.

In an implementation, the processing unit 820 is further configured to: in response to a quantity of IRQs received by the processor in the specified state exceeding a specified threshold, set a part of processors not in the specified state to be used to process the IRQ other than the designated IRQ.

In an implementation, the processing unit 820 is further configured to: detect an application scenario of the computing device; and adjust a quantity of processors currently in the specified state based on a prestored relationship between quantities of processors in the specified state and various application scenarios of the computing device.

An embodiment of this application further provides a computing device. The computing device includes at least one memory and a plurality of processors. The plurality of processors include a main processor. The main processor may perform the technical solutions corresponding to FIG. 2 to FIG. 7(c) and the foregoing corresponding protection, so that the computing device has the technical effect of the foregoing protection technical solutions.

An embodiment of this application further provides a computer-readable storage medium. The computer-readable storage medium stores a computer program. When the computer program is executed in a computer, the computer is enabled to perform the IRQ balancing method according to any one of FIG. 2 to FIG. 7(c) and corresponding descriptions.

An embodiment of this application further provides a computer program product. The computer program product stores instructions. When the instructions are executed by a computer, the computer is enabled to implement the IRQ balancing method according to any one of FIG. 2 to FIG. 7(c) and corresponding descriptions.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of embodiments of this application.

In addition, aspects or features in embodiments of this application may be implemented as a method, an apparatus or a product that uses standard programming and/or engineering technologies. The term “product” used in this application covers a computer program that can be accessed from any computer-readable component, carrier or medium. For example, a computer-readable medium may include but is not limited to: a magnetic storage component (for example, a hard disk, a floppy disk, or a magnetic tape), an optical disc (for example, a compact disc (CD) and a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, include and/or carry instructions and/or data.

In the foregoing embodiments, the IRQ balancing apparatus 800 in FIG. 8 may be fully or partially implemented by using software, hardware, firmware, or any combination thereof. When software is used to implement the foregoing embodiments, all or some of embodiments may be implemented in a form of a computer program product. The computer program product includes one or more computer instructions. When the computer program instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one location, or may be distributed on a plurality of network units. Some or all of the units may be selected based on actual requirements to achieve the objectives of the solutions of embodiments.

When the functions are implemented in a form of a software functional unit and sold or used as an independent product, the functions may be stored in a computer-readable storage medium. Based on such an understanding, the technical solutions of embodiments of this application essentially, or the part contributing to the conventional technology, or a part of the technical solutions may be implemented in a form of a software product. The computer software product is stored in a storage medium, and includes several instructions for instructing a computer device (which may be a personal computer, a server, or an access network device) to perform all or a part of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of embodiments of this application. However, the protection scope of embodiments of this application is not limited thereto. Any change or replacement readily figured out by a person skilled in the art within the technical scope disclosed in embodiments of this application shall fall within the protection scope of embodiments of this application.

1. An interrupt request IRQ balancing method, wherein the method is performed by a computing device, the computing device comprises a plurality of processors, and the method comprises:
obtaining operating statuses of the plurality of processors; and
when a processor is not in a specified state, setting the processor to be used to process a designated IRQ, wherein the specified state comprises one or more of a non-idle (idle) state, an operating frequency being within a preset frequency range, and a load rate being less than a specified load rate; or
when the processor is in the specified state, setting the processor to be used to process an IRQ other than the designated IRQ.

2. The method according to claim 1, wherein the method further comprises:
allocating, according to an interrupt balancing algorithm in a balanced manner, the IRQ other than the designated IRQ to the processor in the specified state.

3. The method according to claim 1, further comprising:
when an operating status of the processor is switched from being in the specified state to being not in the specified state, setting the processor to be used to process the designated IRQ.

4. The method according to claim 1, further comprising:
when the operating status of the processor is switched from being not in the specified state to being in the specified state, setting the processor to be used to process the IRQ other than the designated IRQ.

5. The method according to claim 1, further comprising:
in response to a quantity of IRQs received by the processor in the specified state exceeding a specified threshold, setting a part of processors not in the specified state to be used to process the IRQ other than the designated IRQ.

6. The method according to claim 1, further comprising:
detecting an application scenario of the computing device; and
adjusting a quantity of processors currently in the specified state based on a prestored relationship between quantities of processors in the specified state and various application scenarios of the computing device.

7. A computing device, comprising:
at least one memory; and
a plurality of processors, wherein the plurality of processors comprise a main processor, and the main processor is configured to execute instructions stored in the at least one memory, for the computing device to perform an interrupt request IRQ balancing method comprising:
obtaining operating statuses of the plurality of processors; and
when a processor is not in a specified state, setting the processor to be used to process a designated IRQ, wherein the specified state comprises one or more of a non-idle (idle) state, an operating frequency being within a preset frequency range, and a load rate being less than a specified load rate; or
when the processor is in the specified state, setting the processor to be used to process an IRQ other than the designated IRQ.

8. The computing device according to claim 7, wherein the method further comprises:
allocating, according to an interrupt balancing algorithm in a balanced manner, the IRQ other than the designated IRQ to the processor in the specified state.

9. The computing device according to claim 7, when an operating status of the processor is switched from being in the specified state to being not in the specified state, setting the processor to be used to process the designated IRQ.

10. The computing device according to claim 7, when the operating status of the processor is switched from being not in the specified state to being in the specified state, setting the processor to be used to process the IRQ other than the designated IRQ.

11. The computing device according to claim 7, in response to a quantity of IRQs received by the processor in the specified state exceeding a specified threshold, setting a part of processors not in the specified state to be used to process the IRQ other than the designated IRQ.

12. The computing device according to claim 7, detecting an application scenario of the computing device; and
adjusting a quantity of processors currently in the specified state based on a prestored relationship between quantities of processors in the specified state and various application scenarios of the computing device.

13. A computer-readable storage medium, wherein the computer-readable storage medium stores a computer program, and when the computer program is executed on a computer, the computer is enabled to perform an interrupt request IRQ balancing method comprising:
obtaining operating statuses of the plurality of processors; and
when a processor is not in a specified state, setting the processor to be used to process a designated IRQ, wherein the specified state comprises one or more of a non-idle (idle) state, an operating frequency being within a preset frequency range, and a load rate being less than a specified load rate; or
when the processor is in the specified state, setting the processor to be used to process an IRQ other than the designated IRQ.

14. The computer-readable storage medium according to claim 13, wherein the method further comprises:
allocating, according to an interrupt balancing algorithm in a balanced manner, the IRQ other than the designated IRQ to the processor in the specified state.

15. The computer-readable storage medium according to claim 13, when an operating status of the processor is switched from being in the specified state to being not in the specified state, setting the processor to be used to process the designated IRQ.

16. The computer-readable storage medium according to claim 13, when the operating status of the processor is switched from being not in the specified state to being in the specified state, setting the processor to be used to process the IRQ other than the designated IRQ.

17. The computer-readable storage medium according to claim 13, in response to a quantity of IRQs received by the processor in the specified state exceeding a specified threshold, setting a part of processors not in the specified state to be used to process the IRQ other than the designated IRQ.

18. The computer-readable storage medium according to claim 13, detecting an application scenario of the computing device; and
adjusting a quantity of processors currently in the specified state based on a prestored relationship between quantities of processors in the specified state and various application scenarios of the computing device.
